(19) United States
(12) Patent Application Publication
(10) Pub. No.: US 2021/0016430 A1
(43) Pub. Date: Jan. 21, 2021

(54) CABINET CREEPER

(71) Applicant: Dow Blaine, Atlanta, GA (US)

(72) Inventor: Dow Blaine, Atlanta, GA (US)

(21) Appl. No.: 16/929,599

(22) Filed: Jul. 15, 2020

Related U.S. Application Data
(60) Provisional application No. 62/874,650, filed on Jul. 16, 2019.

(51) Int. Cl. B25H 5/00; A47C 9/02

(52) U.S. Cl. CPC B25H 5/00; A47C 9/027

(57) ABSTRACT

A creeper for accessing cabinets includes a first end and a second end. The creeper includes a base support structure having a top surface, a bottom surface, and a plurality of side walls extending between the top surface and the bottom surface. The base support structure also includes a cabinet entry first end that is shaped and dimensioned for positioning within a cabinet and an exposed second end that is shaped and dimensioned to sit outside of the cabinet when cabinet entry first end of the creeper is positioned within the cabinet for use. A downwardly extending leg assembly is secured along the bottom surface of the base support structure. The cabinet creeper may be used for accessing a cabinet or as a seat with the user sitting directly upon the downwardly extending leg assembly.

### CROSS REFERENCE TO RELATED APPLICATION

This application claims the benefit of U.S. Provisional Patent Application No. 62/874,650, entitled “CABINET CREEPER,” filed Jul. 16, 2019, which is incorporated herein by reference.

### BACKGROUND OF THE INVENTION

### 1. Field of the Invention

The invention relates to a cabinet creeper. In particular, the invention relates to a support structure for users desiring access to a kitchen or bathroom cabinet.

### 2. Description of the Related Art

Many tools and devices have been developed to improve an individual's ability to conveniently access the interior of a cabinet while lying supine upon a support surface. In particular, plumbers and home improvement do it yourselfers are often confronted with the problem of lying supine while positioning their upper body within a cabinet such that they may work upon plumbing or other mechanical structures within the cabinet.

Various developments have been made to address this problem. For example, U.S. Patent Application Publication No. 2011/0049822 to Hinam discloses a plumber's unibody creeper. This creeper provides a wheeled surface similar to a traditional automotive style floor creeper. Other structures have been developed for providing users with access to the interior compartment of a cabinet. For example, U.S. Pat. No. 3,677,569 to Larson discloses a foldable crawler. The crawler includes a pivotally connected extender. A cabinet with rollers is secured to the underside of the device while wheels are also secured to the extender. U.S. Pat. No. 7,305,728 to Schlieps discloses a plumber support pillow including first and second support cushions arranged to support a plumber. Schlieps also discloses the utilization of lamps for illumination within the cabinet. Further, U.S. Pat. No. 8,505,138 to Minichiello et al. discloses an adjustable back platform device. The device includes a base panel having a plurality of adjustable legs extending therefrom and allowing for usage within the storage compartment of a cabinet. U.S. Patent Application Publication Nos. 2001/0024022 to Antirose, 2006/0200902 to Beck, and 2007/0176378 to Bangs disclose a variety of other support devices utilized by plumbers.

While these devices address a variety of concerns to those desiring access to kitchen and bathroom cabinets while lying in a supine position, the devices also exhibit various shortcomings and do not address all problems confronted by those required to work in such a confined space. With this in mind, Applicant has developed the present creeper which is believed to address the shortcomings and provide a convenient, reliable, and effective creeper for utilization in accessing kitchen and bathroom cabinets.

### SUMMARY OF THE INVENTION

In one aspect a creeper for accessing cabinets includes a first end and a second end. The creeper includes a base support structure having a top surface, a bottom surface, and a plurality of side walls extending between the top surface and the bottom surface. The base support structure also includes a cabinet entry first end that is shaped and dimensioned for positioning within a cabinet and an exposed second end that is shaped and dimensioned to sit outside of the cabinet when cabinet entry first end of the creeper is positioned within the cabinet for use. A downwardly extending leg assembly is secured along the bottom surface of the base support structure. The cabinet creeper may be used for accessing a cabinet or as a seat with the user sitting directly upon the downwardly extending leg assembly.

In some embodiments the base support structure is constructed with a substantially rectangular shape when viewed from above and includes a long axis and a short axis.

In some embodiments the plurality of side walls includes first and second long side walls extending parallel to the long axis and first and second short side walls extending parallel to the short axis of the base support structure.

In some embodiments the leg assembly includes a first lateral support leg extending downwardly from the bottom surface of the base support structure at a position between the cabinet entry first end and the exposed second end and the first lateral support leg divides the base support structure into a cabinet entry section that extends from the first lateral support leg to the cabinet entry first end and a lower body support section that extends from the first lateral support leg to the exposed second end.

In some embodiments the first lateral support leg includes an externally facing first planar surface facing the cabinet entry first end of the base support structure and internally facing second planar surface facing the exposed second end of the base support structure.

In some embodiments the leg assembly includes a second lateral support leg that extends downwardly from the bottom surface of the base support structure adjacent the exposed second end thereof.

In some embodiments the second lateral support leg includes an externally facing first planar surface facing the exposed second end of the base support structure and internally facing second planar surface facing the cabinet entry first end of the base support structure.

In some embodiments the creeper includes a support beam extending between the first and second lateral support legs.

In some embodiments the support beam defines a U-shaped profile and is aligned with the long axis of the base support structure.

In some embodiments the support beam includes a central first segment that extends downwardly from the bottom surface of the base support structure, a second segment that extends from the internally facing second planar surface of the second lateral support leg toward the cabinet entry first end, and a third segment that extends from the internally facing second planar surface of the first lateral support leg toward the exposed second end.

In some embodiments the base support structure also includes at least one handle member.

In some embodiments the at least one handle member is an aperture formed along the base support structure.

In some embodiments the base support structure also includes first and second strap apertures.

In some embodiments the first and second strap apertures are adjacent the cabinet entry first end.

In another aspect, a creeper for accessing cabinets includes a first end and a second end. The creeper includes a base support structure having a top surface, a bottom surface, and a plurality of side walls extending between the top surface and the bottom surface. The base support structure also includes a cabinet entry first end that is shaped and dimensioned for positioning within a cabinet and an exposed second end that is shaped and dimensioned to sit outside of the cabinet when cabinet entry first end of the creeper is positioned within the cabinet for use. A downwardly extending leg assembly is secured along the bottom surface of the base support structure. The leg assembly includes a first lateral support leg extending downwardly from the bottom surface of the base support structure at a position between the cabinet entry first end and the exposed second end and the first lateral support leg divides the base support structure into a cabinet entry section that extends from the first lateral support leg to the cabinet entry first end and a lower body support section that extends from the first lateral support leg to the exposed second end. The first lateral support leg includes an externally facing first planar surface facing the cabinet entry first end of the base support structure and internally facing second planar surface facing the exposed second end of the base support structure. The leg assembly also includes a second lateral support leg that extends downwardly from the bottom surface of the base support structure adjacent the exposed second end thereof. The second lateral support leg includes an externally facing first planar surface facing the exposed second end of the base support structure and internally facing second planar surface facing the cabinet entry first end of the base support structure. The cabinet creeper may be used for accessing a cabinet or as a seat with the user sitting directly upon the externally facing first planar surface of the first lateral support leg and the externally facing first planar surface facing of the second lateral support leg sitting upon the ground.

Other advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a top perspective view of the creeper in accordance with the present invention.

FIG. 2 is a side elevation view of the creeper.

FIG. 3 is a bottom view of the creeper.

FIG. 4 shows the creeper in use for sitting upon.

FIG. 5 shows the creeper position in a cabinet ready for use.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

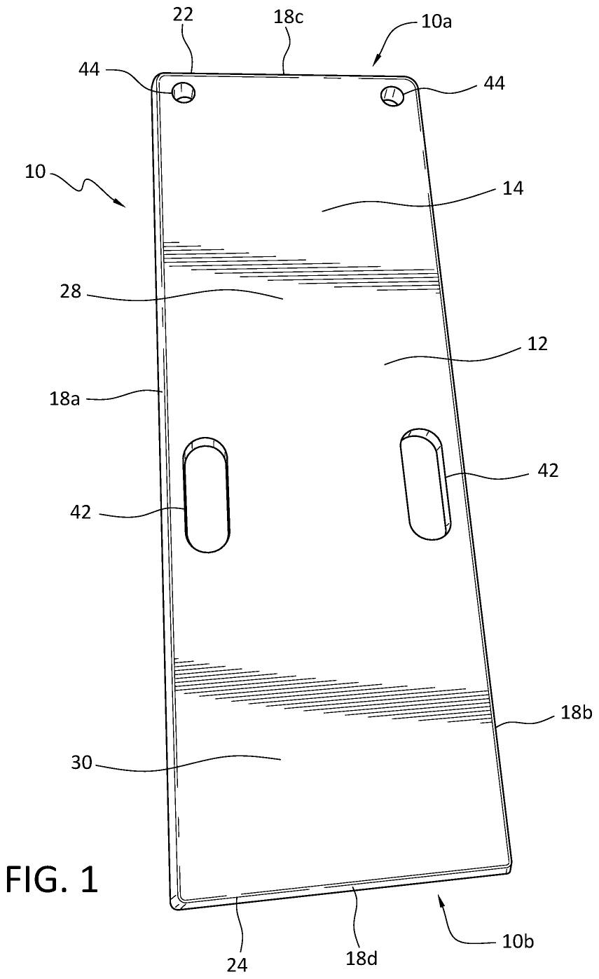

With reference to FIGS. 1 through 5, a creeper 10 for accessing cabinets is disclosed. The creeper 10 allows an individual to position the creeper 10 in front of a cabinet, rest his/her body upon the creeper, and slide into position within the cabinet.

The creeper 10 includes a first end 10a and a second end 10b. The creeper 10 also includes a base support structure 12 including a top surface 14, a bottom surface 16, and a plurality of side walls 18a-d extending between the top surface 14 and the bottom surface 16. A downwardly extending leg assembly 20 is secured along the bottom surface 16 and provides support to keep the user properly positioned relative to the cabinet in which he or she wishes to work.

The base support structure 12 is constructed with a substantially rectangular shape when viewed from above and thereby includes a long axis and a short axis. The plurality of side walls 18a-d therefore includes first and second long side walls 18a, 18b extending parallel to the long axis and first and second short side walls 18c, 18d extending parallel to the short axis of the base support structure 12. The base support structure 12 also includes a cabinet entry first end 22 that is shaped and dimensioned for positioning within a cabinet as discussed below in greater detail. The base support structure 12 also includes an exposed second end 24 that is shaped and dimensioned to sit outside of the cabinet when cabinet entry first end 22 of the creeper 10 is positioned within the cabinet for use.

The leg assembly 20 is shaped and dimensioned for placement upon a support surface, for example, a kitchen or bathroom floor. The leg assembly 20 includes a first lateral support leg 26. The first lateral support leg 26 extends downwardly from the bottom surface 16 of the base support structure 12 at a position between the cabinet entry first end 22 and the exposed second end 24. As such, the first lateral support leg 26 may be thought of as dividing the base support structure 12 into a cabinet entry section 28 that extends from the first lateral support leg 26 to the cabinet entry first end 22 and a lower body support section 30 that extends from the first lateral support leg 26 to the exposed second end 24.

The first lateral support leg 26 includes a upper first edge 26a joined with the bottom surface 16 of the base support structure 12, a lower second edge 26b opposite the upper first edge 26a that is dimensioned for contact with the floor when the creeper 10 is positioned within a cabinet, a first lateral edge 26c extending between the upper first edge 26a and the lower second edge 26b along the left side of the creeper 10 (that is, in alignment with the first long side wall 18a of the base support structure 12), and a second lateral edge 26d extending between the upper first edge 26a and the lower second edge 26b along the right side of the creeper 10 (that is, in alignment with the second long side wall 18b of the base support structure 12). The first lateral support leg 26 also includes an externally facing first planar surface 29 facing the cabinet entry first end 22 of the base support structure 12 and internally facing second planar surface 31 facing the exposed second end 24 of the base support structure 12.

The leg assembly 20 includes a second lateral support leg 32. The second lateral support leg 32 extends downwardly from the bottom surface 16 of the base support structure 12 adjacent the exposed second end 24 thereof. The second lateral support leg 32 includes a upper first edge 32a joined with the bottom surface 16 of the base support structure 12, a lower second edge 32b opposite the upper first edge 32a that is dimensioned for contact with the floor when the creeper 10 is positioned within a cabinet, a first lateral edge 32c extending between the upper first edge 32a and the lower second edge 32b along the left side of the creeper 10 (that is, in alignment with the first long side wall 18a of the base support structure 12), and a second lateral edge 32d extending between the upper first edge 32a and the lower second edge 32b along the right side of the creeper 10 (that is, in alignment with the second long side wall 18b of the base support structure 12). The second lateral support leg 32 also includes an externally facing first planar surface 34 facing the exposed second end 24 of the base support structure 12 and internally facing second planar surface 36 facing the cabinet entry first end 22 of the base support structure 12.

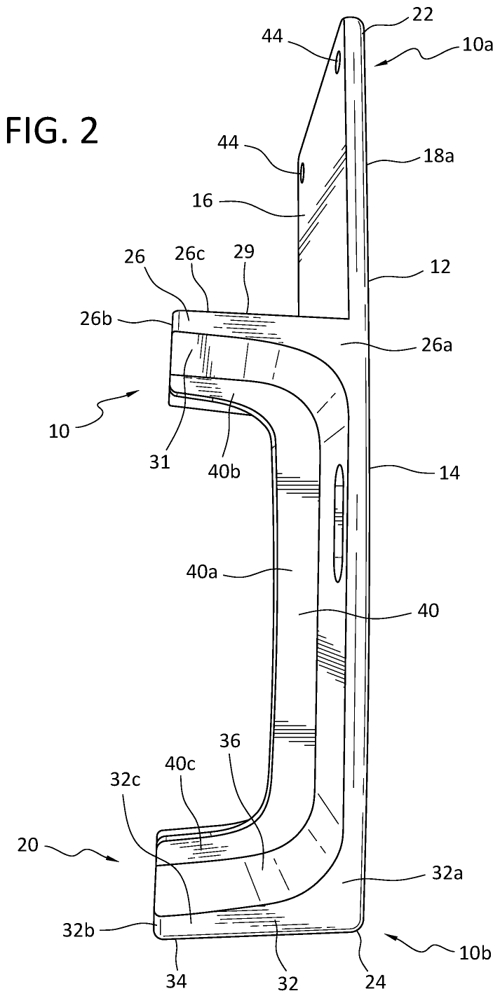

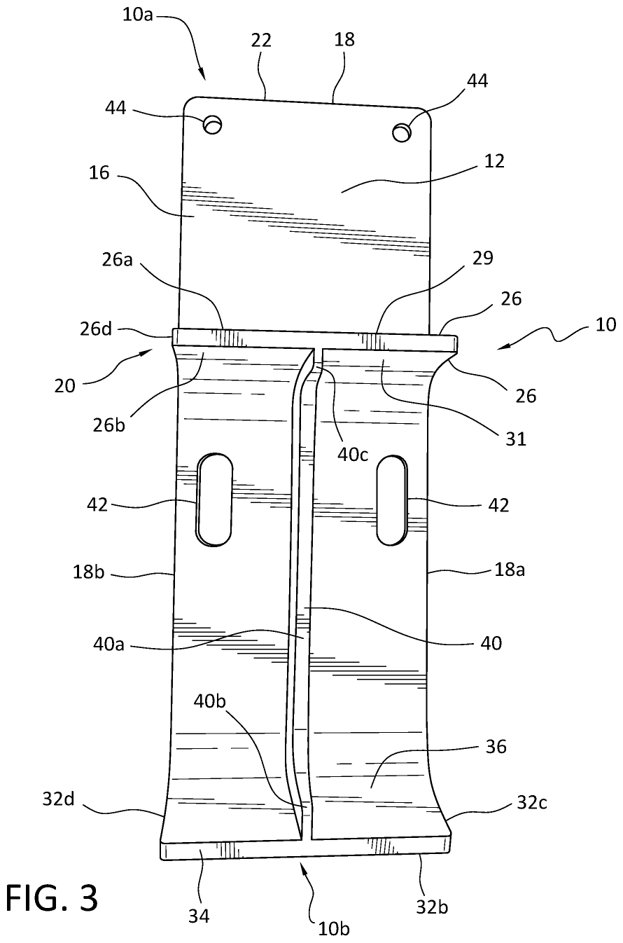

Additional stability is achieved by the provision of a support beam 40 extending between the first and second lateral support legs 26, 32. The support beam 40 defines a U-shaped profile when viewed along the left or right side elevation view as shown in FIGS. 2 and 3. The support beam 40 is aligned with the long axis of the base support structure 12 and extends from the first lateral support leg 26 to second lateral support leg 32. In particular, the support beam 40 may be thought of as including three segments, that is a central first segment 40a that extends downwardly from the bottom surface 16 of the base support structure 12, a second segment 40b that extends from the internally facing second planar surface 36 of the second lateral support leg 32 toward the cabinet entry first end 22, and a third segment 40c that extends from the internally facing second planar surface 30 of the first lateral support leg 26 toward the exposed second end 24.

The base support structure 12 also includes handle members 42 formed therein. In particular, the handle members 42 are defined by oblong apertures formed along the lateral sides of the base support structure 12. The base support structure 12 also includes first and second strap apertures 44 adjacent the cabinet entry first end 22 thereof. The strap apertures 44 are shaped and dimensioned for engagement with an elongated strap (not shown) that can be used when carrying the creeper 10. It is further appreciated a strap (not shown) may be extended from one of the strap aperture 44 to one of the handle members 42 to provide an angled strap arrangement for use when positioning the strap over one's shoulder while carrying the creeper 10. It is further appreciated a handle aperture may be positioned between the strap apertures 44.

When the cabinet creeper 10 is positioned for accessing the cabinet, the cabinet entry section 28 of the base support structure 12 is extended into the cabinet while the lower body support section 30 of the base support structure 12 remains fully outside of the cabinet and upon the support surface on which the creeper 10 sits.

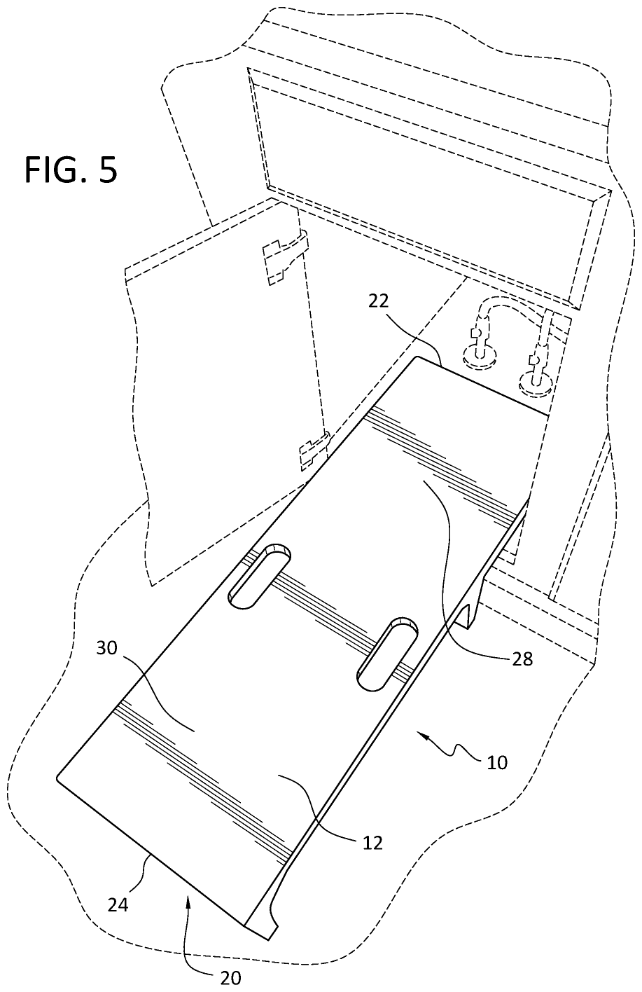

In practice, and with reference in particular to FIG. 5, the user positions the creeper 10 adjacent the cabinet into which the user desires to gain access. The creeper 10 is positioned adjacent the cabinet opening such that either the first lateral support leg 26 is oriented such that the externally facing first planar surface 28 is parallel to, and alignment with, the front wall of the cabinet. With the creeper 10 positioned adjacent the cabinet opening and in alignment with the front wall of the cabinet, the user may rest his or her buttock upon the lower body support section 30 of the base support structure 12 and lean backward with his or her back supported by the cabinet entry section 28 of the base support structure 12.

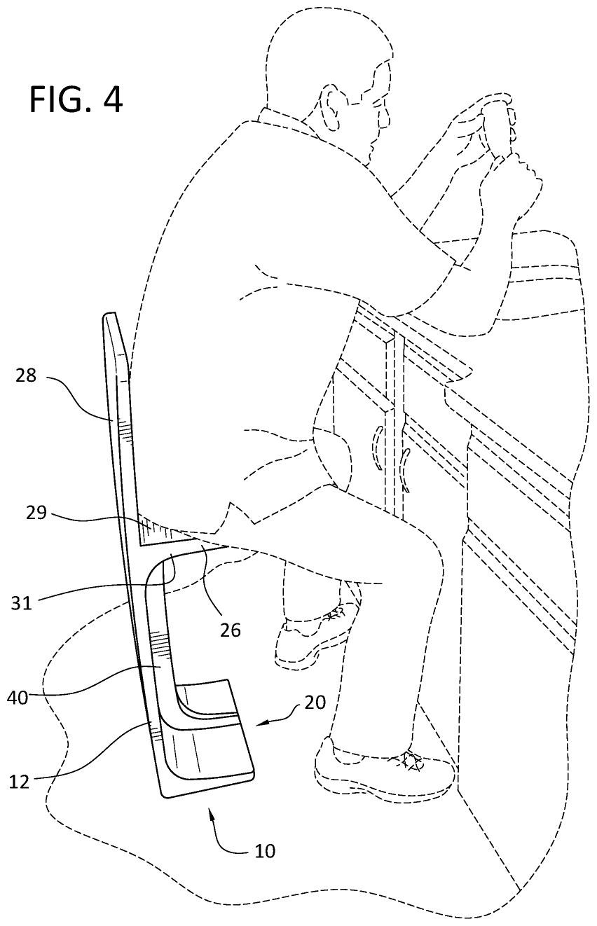

It is further appreciated the versatility of the creeper 10 allows it to be used as a seat. In particular, and with reference to FIG. 4, the externally facing first planar surface 34 of the second lateral support leg 32 is positioned on the floor with the base support structure 12 extending upwardly. The user may then sit upon the externally facing first planar surface 28 of the first lateral support leg 26 with complete stability.

It is appreciated the specific height of cabinets and the openings formed therein vary. As such, the base support structure is positioned at a height that will allow access to a variety of cabinet openings. In accordance with a preferred embodiment, the creeper has the following dimensions: 37 ½ inches—length; 13 ½ inches—width; and 8 ¼ inches—height. Further still, in accordance with a disclosed embodiment, the creeper is of a one-piece construction.

While the preferred embodiments have been shown and described, it will be understood that there is no intent to limit the invention by such disclosure, but rather, it is intended to cover all modifications and alternate constructions falling within the spirit and scope of the invention.

1. A creeper for accessing cabinets including a first end and a second end, comprising:
a base support structure including a top surface, a bottom surface, and a plurality of side walls extending between the top surface and the bottom surface, the base support structure also includes a cabinet entry first end that is shaped and dimensioned for positioning within a cabinet and an exposed second end that is shaped and dimensioned to sit outside of the cabinet when cabinet entry first end of the creeper is positioned within the cabinet for use; and
a downwardly extending leg assembly secured along the bottom surface of the base support structure;
wherein the cabinet creeper may be used for accessing a cabinet or as a seat with the user sitting directly upon the downwardly extending leg assembly.

2. The creeper according to claim 1, wherein the base support structure is constructed with a substantially rectangular shape when viewed from above and includes a long axis and a short axis.

3. The creeper according to claim 2, wherein the plurality of side walls includes first and second long side walls extending parallel to the long axis and first and second short side walls extending parallel to the short axis of the base support structure.

4. The creeper according to claim 1, wherein the leg assembly includes a first lateral support leg extending downwardly from the bottom surface of the base support structure at a position between the cabinet entry first end and the exposed second end and the first lateral support leg divides the base support structure into a cabinet entry section that extends from the first lateral support leg to the cabinet entry first end and a lower body support section that extends from the first lateral support leg to the exposed second end.

5. The creeper according to claim 4, wherein the first lateral support leg includes an externally facing first planar surface facing the cabinet entry first end of the base support structure and internally facing second planar surface facing the exposed second end of the base support structure.

6. The creeper according to claim 4, wherein the leg assembly includes a second lateral support leg that extends downwardly from the bottom surface of the base support structure adjacent the exposed second end thereof

7. The creeper according to claim 6, wherein the second lateral support leg includes an externally facing first planar surface facing the exposed second end of the base support structure and internally facing second planar surface facing the cabinet entry first end of the base support structure.

8. The creeper according to claim 7, further including a support beam extending between the first and second lateral support legs.

9. The creeper according to claim 8, wherein the support beam defines a U-shaped profile and is aligned with the long axis of the base support structure.

10. The creeper according to claim 9, wherein the support beam includes a central first segment that extends downwardly from the bottom surface of the base support structure, a second segment that extends from the internally facing second planar surface of the second lateral support leg toward the cabinet entry first end, and a third segment that extends from the internally facing second planar surface of the first lateral support leg toward the exposed second end.

11. The creeper according to claim 1, wherein the base support structure also includes at least one handle member.

12. The creeper according to claim 11, wherein the at least one handle members is an aperture formed along the base support structure.

13. The creeper according to claim 1, wherein the base support structure also includes first and second strap apertures.

14. The creeper according to claim 13, wherein the first and second strap apertures are adjacent the cabinet entry first end.

15. A creeper for accessing cabinets including a first end and a second end, comprising:
a base support structure including a top surface, a bottom surface, and a plurality of side walls extending between the top surface and the bottom surface, the base support structure also includes a cabinet entry first end that is shaped and dimensioned for positioning within a cabinet and an exposed second end that is shaped and dimensioned to sit outside of the cabinet when cabinet entry first end of the creeper is positioned within the cabinet for use; and
a downwardly extending leg assembly is secured along the bottom surface of the base support structure, the leg assembly includes:
a first lateral support leg extending downwardly from the bottom surface of the base support structure at a position between the cabinet entry first end and the exposed second end and the first lateral support leg divides the base support structure into a cabinet entry section that extends from the first lateral support leg to the cabinet entry first end and a lower body support section that extends from the first lateral support leg to the exposed second end, wherein the first lateral support leg includes an externally facing first planar surface facing the cabinet entry first end of the base support structure and internally facing second planar surface facing the exposed second end of the base support structure;
a second lateral support leg that extends downwardly from the bottom surface of the base support structure adjacent the exposed second end thereof, the second lateral support leg includes an externally facing first planar surface facing the exposed second end of the base support structure and internally facing second planar surface facing the cabinet entry first end of the base support structure;
wherein the cabinet creeper may be used for accessing a cabinet or as a seat with the user sitting directly upon the externally facing first planar surface of the first lateral support leg and the externally facing first planar surface facing of the second lateral support leg sitting upon the ground.

16. The creeper according to claim 15, further including a support beam extending between the first and second lateral support legs.

17. The creeper according to claim 16, wherein the support beam defines a U-shaped profile and is aligned with the long axis of the base support structure.

18. The creeper according to claim 17, wherein the support beam includes a central first segment that extends downwardly from the bottom surface of the base support structure, a second segment that extends from the internally facing second planar surface of the second lateral support leg toward the cabinet entry first end, and a third segment that extends from the internally facing second planar surface of the first lateral support leg toward the exposed second end.
